(19) United States
(12) Patent Application Publication
(10) Pub. No.: US 2008/0294383 A1
(43) Pub. Date: Nov. 27, 2008

(54) Mobile device throughput testing

(76) Inventors: Ramesh Parmar, Union, NJ (US); Bennett Lass, Union, NJ (US); Deepak Gonsalves, Union, NJ (US)

Correspondence Address: MCHALE & SLAVIN, P.A., 2855 PGA BLVD, PALM BEACH GARDENS, FL, 33410, US

(21) Appl. No.: 12/123,823

(22) Filed: May 20, 2008

Related U.S. Application Data
(60) Provisional application No. 60/939,258, filed on May 21, 2007.

(51) Int. Cl. G06F 15/00

(52) U.S. Cl. 702/186

(57) ABSTRACT

The instant invention is a program applet that can be loaded onto mobile devices and directly interfaces with the operating system and automated test scripts. The program applet is capable of initiating the required transfer and will provide information regarding the progress of the transfer such that a test client can properly calculate the data throughput rates.

### CROSS-REFERENCE TO RELATED APPLICATIONS

This application is based upon, and claims priority of, U.S. Provisional Application 60/939,258 filed May 21, 2007 the contents of which is incorporated herein by reference.

### BACKGROUND OF THE INVENTION

The ability to transfer data and access web pages is a standard features for wireless devices. As such there is need to measure performance and determine if a device meets stated requirements.

Wireless devices can be used in one of the two modes for data transfer and web access. In a tethered mode, the wireless device is attached to a PC and is used as a modem. The device provides connectivity, but the data transfer is done between the network server and an application on the PC. This mode of connectivity is used with traditional cell phones.

In a non tethered mode, the device is not attached to a PC; the device itself is capable of initiating a FTP or HTTP transfer. This mode is more frequently used with smart phones that have a WINDOWS, PALM, Symbian, Blackberry etc., based operating system. In these devices, the UI on the device allows the user to initiate either the file transfer or the web access.

Non-tethered testing mode requires a native FTP and HTTP agent on the device which can be controlled programmatically via test scripts which reside on a test controller PC.

Automated testing of wireless mobile devices for data functionality and performance require the ability to transfer files and web pages via FTP and HTTP protocols respectively. When the testing utilizes the mobile device as a modem, a test agent on the PC can be used to automate this process.

A problem uncovered is the inability to provide accurate mobile device measurement which assimilates operational characteristics likely to be encountered under normal and heavy consumer use.

Thus, what is needed in the art is a means for measuring the performance of a mobile device that assimilates actual consumer conditions.

### SUMMARY OF THE INVENTION

Disclosed is a program applet that is loaded onto a mobile device. The program applet provides APIs which allows access to the OS and call processing features and functions required by the automated test scripts to measure data throughput.

An objective of the program applet is to assimilate: Initiation and Termination of data call; FTP Upload; FTP Download; FTP Bi-directional File transfer; HTTP Upload; HTTP Download; HTTP Bi-directional File transfer; HTTP Download (Web Access); Screen Capture; Key Press and other features that may be particular to the mobile device.

Another objective of the invention is to create an applet that can be loaded onto the mobile devices and directly interface with the operating system and automated test scripts.

Still another objective of the program applet of the instant invention is act an applet on a test device wherein automated scripts will control the program applet and initiate the required data transfer.

Yet still another objective of the instant invention is for use of a program applet to obtain information regarding the progress of data transfer such that the test device can properly calculate the data throughput rates.

Another objective of the instant invention is to provide a program applet that behaves as a client server application, allows the user to connect to the device, remotely invoke API commands and examine the information returned from the device.

Still another objective of the program applet is to cause operation of the program as either background application or a service.

Yet still another objective of the instant invention is for use of a program applet having a small memory footprint so as not to impact the operation of the device.

Still another objective of the instant invention is for use of a program applet that works with all phones including Windows, PALM, Symbian, Linux and so forth.

Another objective of the instant invention is for use of a program applet that is agnostic to the wireless cellular technology and works through the OS APIs, thus allows working on both CDMA and GSM based phones.

These and other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a flow diagram depicting the interface between a desktop module and a device module;

FIG. 2 is a flow diagram illustrating an infrared connection;

FIG. 3 is a flow diagram depicting a flow diagram of a mobile device data throughput testing using a program applet.

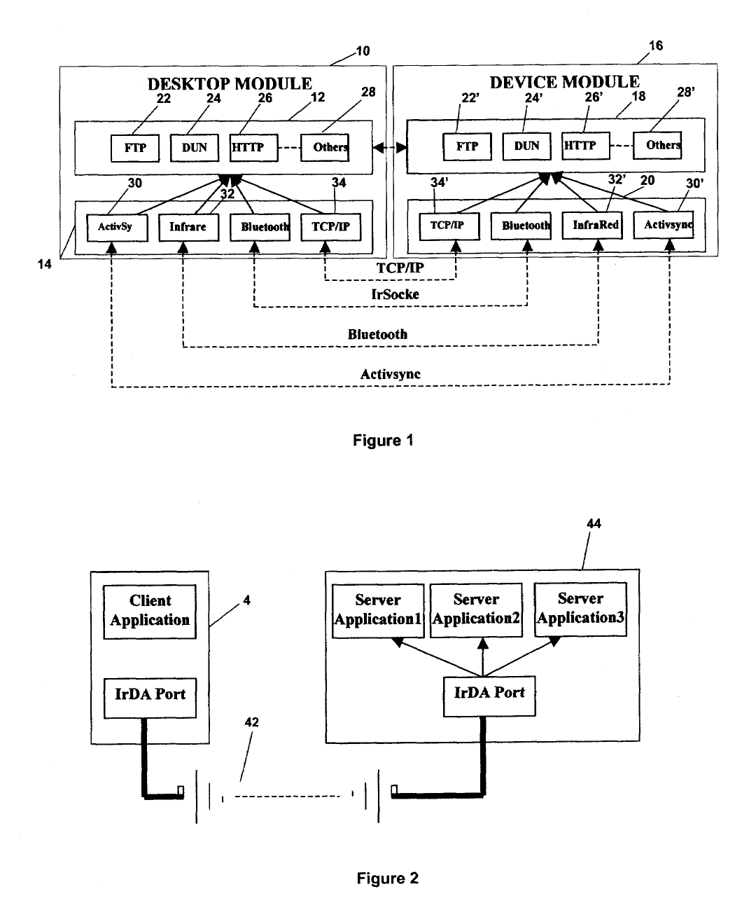

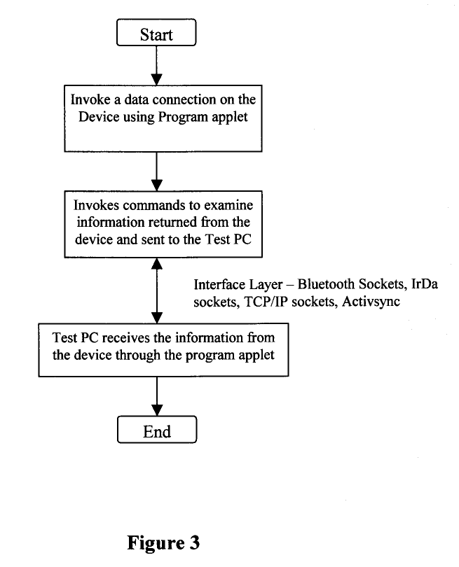

### DETAILED DESCRIPTION OF THE PREFERRED EMBODIMENT

Referring now to the Figures, set forth is the overall architecture of the test environment with the incorporation of the program applet of the instant invention. The Architecture depicts a desktop module 10 with an Application Layer 12 shown as Dial-Up Networking, FTP, HTTP, Others and a Transport Medium Layer 14 shown as Activsync, InfraRed, Bluetooth, TCP/IP adaptors. Similarily, the device module 16 has an Application Layer 18 shown as Dial-Up Networking, FTP, HTTP, Others and a Transport Medium Layer 20 shown as Activsync, InfraRed, Bluetooth, TCP/IP adaptors.

The Application layer File Transfer Protocol (FTP) 22 & 22′ is software that is designed to transfer files back-and-forth between two computers over the Internet. FTP is a protocol used for exchanging files over any TCP/IP based network to manipulate files on another computer on that network regardless of which operating systems are involved (if the computers permit FTP access).

The Application layer Dial-up Networking (DUN) 24 & 24′ is a feature that enables a Mobile Device to function as a wireless modem. DUN profile provides a standard to access the Internet and other dial-up services. The most common scenario is accessing the Internet from a laptop by using mobile device as modem.

Hypertext Transfer Protocol (HTTP) 26 & 26′ is a request/response standard between a client and a server. Typically, an HTTP client initiates a request. It establishes a Transmission Control Protocol (TCP) connection to a particular port on a host (port 80 by default; see List of TCP and UDP port numbers). An HTTP server listening on that port waits for the client to send a request message. Upon receiving the request, the server sends back a status line, such as “HTTP/1.1 200 OK”, and a message of its own, the body of which is perhaps the requested file, an error message, or some other information.

Others 28 & 28′ include Key press and Image Capture functionality—Every Key press on the device is controlled by the program applet and provides a full control for executing Automation Scripts. It also has inbuilt functions to take snapshots on the device screen and send it to the Test PC in a bitmap or jpeg format

The Transport Medium Layer includes an ActivSync Adaptor 30 & 30′ which acts as the gateway between a Windows-based PC and Windows Mobile-based device, enabling the transfer of Outlook information, Office documents, pictures, music, videos and applications to and from the device. This Adaptor on the PC communicates with the Activsync Adaptor on the MOBILE DEVICES using RAPI calls.

The Infrared Adaptor 32 & 32′ IrDA standard contains all fundamental specifications for wireless data communication via infrared. Thus the greatest possible compatibility between devices of different manufacturers can be reached. The IrDA has published a set of standards that define the physical and software-specific layers necessary for smooth communication between two infrared devices. The Test PC and Mobile device uses the Infrared sockets to invoke the RAPI calls which will be used for mutual communication, execution of specific commands for automating the device.

With the implementation of the infrared connection it is enough to know the following: each IrDA server application 40 that maintains the infrared connection 42 enables such an LSAP selector and a service name. Each Client application uses this kind of the addressing to build up a connection to the server application 44. All well-known Socket functions (like “send” or “recv”) can be used in their usual way accordingly to these restrictions and changes. The LSAP selector can be compared with a port number under TCP/IP and corresponds to a number between 0 and 127. If one wants to address the IrDA equipment, he can select either a desired LSAP Selector or indicate a service name, whereby a free LSAP Selector is selected automatically.

The Transmission Control Protocol (TCP) is one of the core protocols of the Internet protocol suite. TCP provides reliable, in-order delivery of a stream of bytes, making it suitable for applications like file transfer and e-mail. It is so important in the Internet protocol suite that sometimes the entire suite is referred to as “the TCP/IP protocol suite.” TCP is the transport protocol that manages the individual conversations between web servers and web clients. TCP divides the HTTP messages into smaller pieces, called segments, to be sent to the destination client. It is also responsible for controlling the size and rate at which messages are exchanged between the server and the client. The Test PC and Mobile device uses the TCP/IP sockets 34 & 34′ to invoke the RAPI calls which will be used for mutual communication, execution of specific commands for automating the device TCP uses the notion of port numbers to identify sending and receiving application end-points on a host, or Internet sockets. Each side of a TCP connection has an associated 16-bit unsigned port number (1-65535) reserved by the sending or receiving application. Arriving TCP data packets are identified as belonging to a specific TCP connection by its sockets, that is, the combination of source host address, source port, destination host address, and destination port. This means that a server computer can provide several clients with several services simultaneously, as long as a client takes care of initiating any simultaneous connections to one destination port from different source ports.

Remote API (RAPI) is a remote procedure call (RPC) that enables communication between two applications. The prototypes that are defined in the Rapi.h file enable desktop computer applications to remotely manage devices. RAPI communicates requests from a desktop computer application to invoke a function and returns the results of that function. The exported functions relate to the registry, file system, and databases, in addition to functions for querying the system configuration. Although most RAPI functions are duplicates of functions in the Microsoft® Windows® CE API, a few new functions extend the API.

The Mobile Devices can be seen as being two areas that work in tandem. The OS controls the main interface to the user as well as application such as the phonebook, SMS, MMS, camera, etc. The OS can be any standard OS but not limited to Windows, Palm, Linux, Symbian, etc. The phone system is responsible for managing call processing. The phone system can be based on any mobile technology such as but not limited to CDMA, TDMA, GSM, WCDMA, EDGE, GPRS, EVDO, etc. In the remainder of the document, Windows and CDMA will be used as generic terms for the OS and cellular technology respectively.

When testing data throughput on Mobile Devices like smart phones, the phone is connected to a PC based test client which has a FTP and HTTP file transfer client program. During the testing, the PC client establishes a data call through the mobile device which acts as a modem. Once the data connection is established the required file transfer or HTTP page download is executed. The test client monitors the first and last data packet as well as the elapsed time. This allows the calculation of data throughput rates.

When operating in the non-tethered mode, the data connection is created directly from the device. Once the connection is established, the data application can ride on top of the data connection.

A proposed solution to this issue is to create the program applet that can be loaded onto the mobile devices and directly interface with the operating system and automated test scripts. The program applet will act as an Applet on the test device. The automated scripts will control the applet and initiate the required data transfer. The applet will provide information regarding the progress of the transfer such that the test client can properly calculate the data throughput rates.

The program is an applet on the mobile device which can be controlled by the automated test scripts. To complete the automated test scenario, a “glue” layer is needed to allow the test scripts to interface with the program applet API. This glue layer also includes a transport mechanism which can be, but not limited to ActivSync, Bluetooth, IR, Wireless (WiFi or WiMax) etc.

The program applet behaves as a client server application. It allows the user to connect to the device, remotely invoke API commands and examine the information returned from the device.

The program applet allows the user to initiate a file transfer in either FTP or HTTP protocol. The allowable transfers should be upload, download and bi-directional.

The API in the program applet allows test scripts running on a test PC to control file transfers and HTTP webpage access.

During the execution of automated scripts, the scripts invoke the program applet via the interface layer which resides on the test PC. The interface layer and program applet are responsible for establishing and maintaining communications. The communication between the script and the program applet support bi-directional communications allowing the script to make calls to the program applet API via the interface layer and obtain the return values. Communications from the script through the interface is supported by different physical layer based connections such as USB or serial communications for hardwired connects and via IR or Bluetooth for wireless communications. The protocol used for communications should similar to ActivSync.

The program applet captures the snapshot of the device and sends it to the Test PC. Every Key press on the device is controlled by the program applet and provides a full control for executing Automation Scripts: supports “Key tap”; supports “Dial Number”; supports “Answer Call”; supports “End Call”; Supports Navigation such as “Open Message & Close Message”. The program applet starts automatically when the device is power cycled. It also re-establishes communications with the interface layer.

The program applet has functions on the client and server to support key taps and display captures.

KEY TAPS—During execution of automated scripts, simulating key taps on the smart device without user intervention is a big task. The program applet has built-in functions which uses the following methods for the key tap simulation: Virtual Key Code mapping to simulate the Key Tap functionality; and taking the coordinates on the screen before configuring and simulating them at a later stage.

DISPLAY CAPTURE—The program applet has built-in functions to take snapshots on the device screen and send it to the Test PC in a bitmap or jpeg format.

The following Instruction commands are implemented in the program applet. These actions can be accessed by test scripts or test clients. Unless otherwise noted, the function is applicable to both FTP and HTTP:

InitializeTransferProtocols: Provides instructions to initialize Data Transfer Protocols.
DoTransfer: Provides instructions to start Data Transfer on the device.
DoPing: Instructions to PING the device.
GetTransferStatistics: Provides instructions to get the data transfer statistics from the device.
Upload Statistics:
   Number of bytes transferred;
   Number of bytes already transferred;
   Number of bytes still to transfer;
   Elapsed Time;
   Throughput value.
Download Statistics:
   Number of bytes to transfer;
   Number of bytes already transferred;
   Number of bytes still to transfer;
   Elapsed time;
   Throughput value.
      IsExceptionAvailable: Provides instructions for exception handling:
Upload or download exception errors;
Any return time values that provides either an absolute time or an elapsed time should be in milliseconds.
   TerminateApplication: Provides instructions for terminating the “program applet” application.
   CloseTransferProtocols: Provides instructions to close the Data Transfer Protocols.
   EnumerateDataConnections: Provides instructions to get the count of Data connections.
   InitiateDataCall: Provides instructions to initiate a Data Call.
   TerminateDataCall: Provides instructions to terminate a Data Call.

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the stated claims or objectives.

1. A method of testing data throughput rate on a mobile device comprising the steps of:
coupling said mobile device to a PC based test client capable of electronic file transfer;
establishing a data transfer connect between said PC based test client and said mobile device, said mobile device operating as a modem;
loading a program applet onto said mobile device; and
initiating a data transfer;
wherein said applet provides data for determining the elapsed time of file transfer and calculating the data throughput rates.

2. The method of testing data throughput rate according to claim 1 wherein said applet is controlled by said automated test scripts.

3. The method of testing data throughput rate according to claim 1 wherein said automated test scripts includes a transport mechanism for coupling by ActivSync.

4. The method of testing data throughput rate according to claim 1 wherein said automated test scripts includes a transport mechanism for coupling by Bluetooth.

5. The method of testing data throughput rate according to claim 1 wherein said automated test scripts includes a transport mechanism for coupling by Infrared.

6. The method of testing data throughput rate according to claim 1 wherein said automated test scripts includes a transport mechanism for coupling by WiFi.

7. The method of testing data throughput rate according to claim 1 wherein said automated test scripts includes a transport mechanism for coupling by WiMax.

8. The method of testing data throughput rate according to claim 1 wherein said applet operates as a client server application to remotely invoke API commands and examine the information returned from the device.

9. The method of testing data throughput rate according to claim 1 wherein said electronic file transfer is a FTP protocol.

10. The method of testing data throughput rate according to claim 1 wherein said electronic file transfer is a HTTP protocol.

11. The method of testing data throughput rate according to claim 1 wherein electronic file transfer can be uploaded, downloaded and bi-directional.

12. The method of testing data throughput rate according to claim 1 wherein said program applet instructs test scripts running on a PC based test client by use of an interface layer residing on the PC based test client to control file transfers and HTTP webpage access.

13. The method of testing data throughput rate according to claim 1 wherein said program applet is loaded on the device through ActivSync, Wireless transfer, or through SMS as hyperlink to download.

14. The method of testing data throughput rate according to claim 1 wherein said program applet further comprising the steps of:
initializing Data Transfer Protocols and starting of instructions to start Data Transfer on the device;
providing instructions to PING the device; and
uploading or downloading of data transfer statistics from the device.

15. The method of testing data throughput rate according to claim 14 wherein said uploading of data transfer includes:
recording the number of bytes transferred;
determining the number of bytes already transferred;
calculating the number of bytes still to transfer;
registering of the elapsed Time; and
calculating the throughput value.

16. The method of testing data throughput rate according to claim 14 wherein said downloading of data transfer includes:
recording the number of bytes transferred;
determining the number of bytes already transferred;
calculating the number of bytes still to transfer;
registering of the elapsed Time; and
calculating the throughput value.

17. The method of testing data throughput rate according to claim 1 wherein said program applet includes the steps of:
providing of instructions for exception handling by uploading or downloading exception errors;
determining return time values that provides either and absolute time or an elapsed time.

18. The method of testing data throughput rate according to claim 1 wherein said program applet includes the step of providing instruction for terminating of the program applet.

19. The method of testing data throughput rate according to claim 1 wherein said program applet includes the step of providing instructions to close the Data Transfer Protocols.

20. The method of testing data throughput rate according to claim 1 wherein said program applet includes the step of providing instructions to get the count of Data connections.

21. The method of testing data throughput rate according to claim 1 wherein said program applet includes the step of providing instructions to initiate a Data Call and terminate a Data Call.

22. A method of testing data throughput rate on a mobile device comprising the steps of:
coupling said mobile device to a PC based test client capable of electronic file transfer;
establishing a data transfer connect between said PC based test client and said mobile device, said mobile device operating as a modem;
loading a program applet having automated test scripts onto said mobile device;
initializing Data Transfer Protocols and starting of instructions to start Data Transfer on the device;
providing instructions to PING the device;
uploading or downloading of data transfer statistics from the device and recording the number of bytes transferred;
determining the number of bytes already transferred;
calculating the number of bytes still to transfer;
registering of the elapsed time; and
calculating the throughput value;
wherein said applet provides data for determining the elapsed time of file transfer and calculating the data throughput rates.

23. The method of testing data throughput rate according to claim 22 wherein said automated test scripts includes a transport mechanism for coupling by ActivSync.

24. The method of testing data throughput rate according to claim 22 wherein said automated test scripts includes a transport mechanism for coupling by Bluetooth.

25. The method of testing data throughput rate according to claim 22 wherein said automated test scripts includes a transport mechanism for coupling by Infrared.

26. The method of testing data throughput rate according to claim 22 wherein said automated test scripts includes a transport mechanism for coupling by WiFi.

27. The method of testing data throughput rate according to claim 22 wherein said automated test scripts includes a transport mechanism for coupling by WiMax.

28. The method of testing data throughput rate according to claim 22 wherein said applet operates as a client server application to remotely invoke API commands and examine the information returned from the device.

29. The method of testing data throughput rate according to claim 22 wherein said electronic file transfer is a FTP protocol.

30. The method of testing data throughput rate according to claim 22 wherein said electronic file transfer is a HTTP protocol.

31. The method of testing data throughput rate according to claim 22 wherein electronic file transfer can be downloaded or bi-directional.

32. The method of testing data throughput rate according to claim 22 wherein said program applet instructs test scripts running on a PC based test client by use of an interface layer residing on the PC based test client to control file transfers and HTTP webpage access.

33. The method of testing data throughput rate according to claim 22 wherein said program applet includes the steps of:
providing of instructions for exception handling by uploading or downloading exception errors;
determining return time values that provides either and absolute time or an elapsed time.

34. The method of testing data throughput rate according to claim 22 wherein said program applet includes the step of providing instruction for terminating of the program applet.

35. The method of testing data throughput rate according to claim 22 wherein said program applet includes the step of providing instructions to close the Data Transfer Protocols.

36. The method of testing data throughput rate according to claim 22 wherein said program applet includes the step of providing instructions to get the count of Data connections.

37. The method of testing data throughput rate according to claim 22 wherein said program applet includes the step of providing instructions to initiate a Data Call and terminate a Data Call.
